(19) United States
(12) Patent Application Publication
(10) Pub. No.: US 2024/0152857 A1
(43) Pub. Date: May 9, 2024

(54) Analyzing and Managing Shipping Data Across Jurisdictions and Regions

(71) Applicant: PROJECT44, LLC, Chicago, IL (US)

(72) Inventors: Troy Mass, Oak Park, IL (US); Ralph Edward Brendler, Berrien Springs, MI (US); Elwood William Hansmann, River Forest, IL (US); Mark Greshammer, Oak Park, IL (US); Ping Luo, Pleasanton, CA (US)

(21) Appl. No.: 17/980,952

(22) Filed: Nov. 4, 2022

(51) Int. Cl. G06Q 10/0833

(52) U.S. Cl. CPC G06Q 10/0833

(57) ABSTRACT

Systems and methods for using machine learning to dynamically determine shipping information are disclosed. According to certain aspects, an electronic device may receive location data for a set of vehicles that may be associated with a shipping agreement, wherein the electronic device may input the location data and shipping agreement parameters into a machine learning model which outputs a set of likelihoods of the respective set of vehicles actually transporting products associated with the shipping agreement. The electronic device may enable a customer computing device to access this information along with any determined updates to the shipping agreement.

### FIELD

The present disclosure is directed to improvements related to analyzing and managing shipping data across multiple regions. More particularly, the present disclosure is directed to platforms and technologies for analyzing and determining whether particular regional policies apply to a user attempting to access shipping data, as well as taking action to comport with said regional policies when invoked.

### BACKGROUND

The transportation and logistics industry is made up of various entities that contract or agree to handle the transportation of physical items between and among locations. In particular, the transportation and logistics industry generally includes shippers (i.e., entities having physical items to transport) and carriers entities having transport equipment to transport the physical items), There are additional entities known as third-party logistics (3PL) entities that receive quote requests from shippers, determine rates offered by the carriers to accommodate the requests, and ultimately broker shipping agreements between a shipper and a carrier. Communication among the shippers, 3PL entities, and carriers may be facilitated using Transportation Management Systems (TMS).

Shippers, carriers, 3PL entities, and/or other interested parties may be located in different regions and/or jurisdictions along a shipment path for the items and may prefer to have access to information regarding the location, status, ETA, etc. of the shipment in question. However, some regions have policies, laws, and rules governing what, when, and with whom information regarding a shipment may be shared. For example, some regions do not allow particular location data to be shared with entities located outside of the region.

Accordingly, there is an opportunity for platforms and technologies to analyze shipment orders, user location data, regional policies, and/or other pertinent information to determine whether a regional policy or regional policies require particular data to be obfuscated for individual users and to obfuscate said particular data for only the individual users in question.

### SUMMARY

In an embodiment, a computer-implemented method of tracking and sharing shipment data is provided. The method may include: (i) receiving, by one or more processors, a request from a user to track a shipment, the shipment having a shipment path specifying a plurality of regions; (ii) retrieving, by the one or more processors, user characteristic data from a user profile associated with the user, the user characteristic data indicating a user location; (iii) retrieving, by the one or more processors, a regional tracking policy for each region of the plurality of regions in the shipment path; (iv) determining, by the one or more processors and based on the user location, whether the regional tracking policy for each region of the plurality of regions in the shipment path applies to the user; and (v) responsive to the determining whether the regional tracking policy for each region of the plurality of regions in the shipment path applies to the user: (a) obfuscating at least part of a set of tracking data of the shipment in accordance with the regional tracking policy when the regional tracking policy applies, including not availing the at least part of the set of tracking data for display in a user interface, and (b) refraining from obfuscating the set of tracking data when the regional tracking policy does not apply.

In another embodiment, a computing system for tracking and sharing shipment data is provided. The system may include: (A) one or more processors; and (B) a non-transitory computer-readable medium coupled to the one or more processors and the communication unit and storing instructions thereon that, when executed by the one or more processors, cause the computing system to: (i) receive a request from a user to track a shipment, the shipment having a shipment path specifying a plurality of regions; (ii) retrieve user characteristic data from a user profile associated with the user, the user characteristic data indicating a user location; (iii) retrieve a regional tracking policy for each region of the plurality of regions in the shipment path; (iv) determine, based on the user location, whether the regional tracking policy for each region of the plurality of regions in the shipment path applies to the user; and (v) responsive to the determining whether the regional tracking policy for each region of the plurality of regions in the shipment path applies to the user: (a) obfuscate at least part of a set of tracking data of the shipment in accordance with the regional tracking policy when the regional tracking policy applies, including not availing the at least part of the set of tracking data for display in a user interface, and (b) refrain from obfuscating the set of tracking data when the regional tracking policy does not apply.

### BRIEF DESCRIPTION OF THE FIGURES

FIG. 1A depicts an overview of components and entities associated with the systems and methods, in accordance with some embodiments.

FIG. 1B depicts an overview of certain components configured to facilitate the systems and methods, in accordance with some embodiments.

FIG. 2A depicts an example scenario in which a system obfuscates data for one region in a shipment path for a user to which a regional policy applies, in accordance with some embodiments.

FIG. 2B depicts an example scenario similar to that of FIG. 2A, but in which the system does not obfuscate data for another user to which the regional policy does not apply, in accordance with some embodiments.

FIG. 2C depicts an example scenario similar to that of FIG. 2A, but in which the user to which the regional policy does not apply receives unobfuscated data, while the user for which the policy does apply receives obfuscated data, in accordance with some embodiments.

FIG. 2D depicts an example scenario similar to that of FIG. 2C, but in which the user to which the regional policy applies receives the obfuscated data and transmits data to the second user, which is unobfuscated, in accordance with some embodiments.

FIG. 2E depicts an example scenario similar to that of FIG. 2A, but in which a user associated with the user of FIG. 2A but to which the regional policy does not apply receives data that the system does not obfuscate, in accordance with some embodiments.

FIG. 3A depicts an exemplary block diagram for a system that receives a tracking request from a client for a shipment and distributes said tracking requests to various regional datacenters to track the progress of the shipment, in accordance with some embodiments.

FIG. 3B depicts an exemplary block diagram for a system similar to that of FIG. 3A, but in which the datacenters provide tracking data to the first region datacenter, which subsequently assembles the tracking data and provides it to the client, in accordance with some embodiments.

FIG. 4 depicts an exemplary block diagram for a system that gathers, analyzes, and shares data regarding a particular shipment or shipments, as well as the flow of information within the shipment, in accordance with some embodiments.

FIG. 5 depicts an example block diagram of a circle of trust including at least two tenant entities, each entity storing data related to the tenant and/or shipments for the tenant, in accordance with some embodiments.

FIG. 6A depicts an example dashboard interface for a shipper entity in which the system does not obfuscate location data, in accordance with some embodiments.

FIG. 6B depicts an example dashboard interface similar to that of FIG. 6A, but in which the system obfuscates some location data for a user, in accordance with some embodiments.

FIG. 7 illustrates an example flow diagram of gathering data and determining whether to apply a policy and/or obfuscate data for a user, in accordance with some embodiments.

FIG. 8 illustrates an example flow diagram of receiving a tracking request, tracking data, merging the shipment data, and determining whether to obfuscate parts of the data before providing the data to the client, in accordance with some embodiments.

### DETAILED DESCRIPTION

The present embodiments may relate to, inter alia, receiving, analyzing, and/or obfuscating tracking information associated with a shipping agreement or job based on whether a user triggers a shipping policy (e.g., regional policies, tenant policies, modal policies, etc.), and updating a status for the shipping agreement for access by the user (e.g., a shipper entity) based on any applied policies. According to certain aspects, systems and methods may obfuscate data for some users to receive information regarding a shipment, but not all (e.g., a supplier may not trigger a policy, but a company to ultimately receive the information may require the system to obfuscate information).

The systems and methods disclosed herein may further authenticate a user location based on a circle of trust and/or may determine that a user is attempting to trick and/or spoof the policy by recording a different location. Further, the systems and method disclosed herein may instead use trusted information authenticated by and/or stored within the circle of trust in determining whether various policies apply to the user. Moreover, the systems and methods described herein may obfuscate tracking data by omitting data, redacting data, providing a disclaimer to a user, sharing an aggregate of shipping information in the form of a milestone rather than precise location data, etc. In implementations in which the user shares data with another user in the circle of trust, the systems and methods herein may generate a copy of the shipping information for the second user and obfuscate information differently for the original shipping information to present to the first user and the copy of the shipping information for the second user.

The systems and methods therefore offer numerous benefits. In particular, the systems and methods access and apply regional policies, tenant policies, modal policies, etc., thereby reducing the amount of computing and processing required, as only the systems and methods apply the policies only to the data for the particular users to which the policies apply, rather than broadly applying the policies in question to all shipments in regions with such policies. Further, the systems and methods are able to accurately determine status updates for shipping agreements, including locations, estimated delivery times, and/or other information, as well as present such information to users who are authorized and/or otherwise allowed to view the information in question. Additionally, customers who do not trigger policies benefit from being able to access updated information associated with shipping agreements, such as to streamline supply chain gaps and provide accurate updates to their customers, among other benefits, while customers who do trigger policies maintain access to at least some information and, depending on the embodiment, general milestones for prohibited information.

Moreover, the use of a circle of trust in authenticating a user location before determining whether to obfuscate information for the user in question reduces the potential for fraud by improving ability to authenticate a user location as well as providing additional measures for authenticating a user identity. As such, the circle of trust improves both security and privacy for users. Further, in some implementations, assembling policies before applying the policies to a shipment and/or user improves the general processing speed by centralizing the operations required to apply obfuscation based on policies. It should be appreciated that additional benefits are envisioned.

The systems and methods discussed herein further address a business challenge, namely a business challenge related to improving how shipper entities legally track their shipments across one or more carrier entities. In conventional platforms, shipper entities have access to which carrier entities are completing which shipping agreements, but do not necessarily know the locations of the vehicles that are transporting the products associated with the shipping agreements. Further, those few conventional platforms capable of potentially providing more particular information do not properly distinguish those users allowed to view particular information and those users that are not, instead broadly preventing all users from accessing such specific information to avoid infringing on various regional policies, tenant policies, modal policies, etc. In contrast, the systems and methods are able to ingest or access data from multiple data sources and analyze that data to assess the locations and statuses of shipments as well as determine for which users such information should be obfuscated, thus enabling allowed shipping entities to review the information and more effectively and efficiently manage operations while still providing at least some information to shipping entities not allowed to review the information in question.

Therefore, the systems and methods do not merely recite the performance of some business practice known from the pre-Internet world (tracking a shipment) along with the requirement to perform it on the Internet. Instead, the systems and methods incorporate computer networks that enable communications among shipper entities, carrier entities, and data sources as well as that enable analysis of such entities and/or sources to determine applicability of various policies. Thus, the systems and methods are necessarily rooted in computer technology in order to overcome a problem specifically arising in logistics technologies.

According to implementations, the systems and methods may support a dynamic, real-time or near-real-time collection, analysis, and communication of any data that may be associated with shipping conditions. In particular, the systems and methods may dynamically and automatically access or retrieve data indicative of operational conditions such as vehicle locations, analyze the data, and determine whether to obfuscate such data. In these ways, the systems and methods discussed herein address technical challenges, namely establishing dynamic data collection, analysis, obfuscation, and/or communication across dedicated computer systems, including different systems for different carrier entities, shipper entities, users, and/or regions.

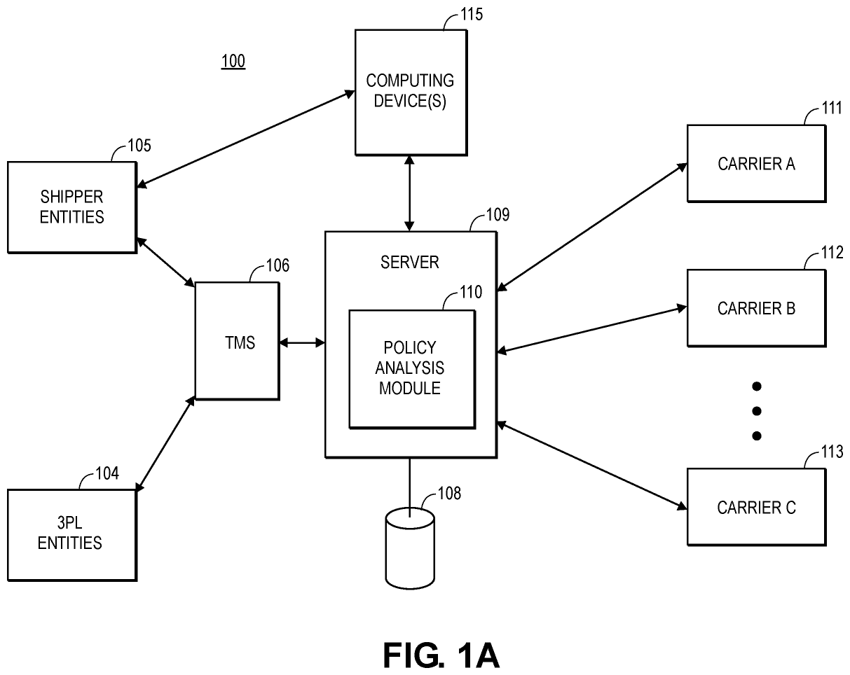

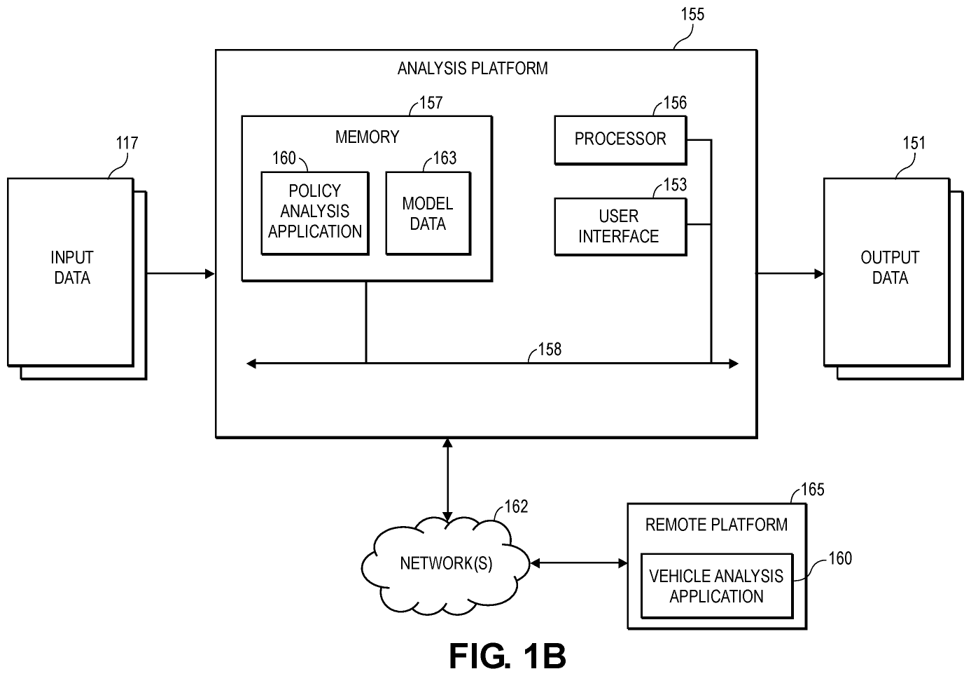

FIG. 1A illustrates an overview of a system 100 of components configured to facilitate the systems and methods. It should be appreciated that the system 100 is merely exemplary and that alternative or additional components are envisioned.

As illustrated in FIG. 1A, the system 100 includes a set of shipper entities 105 and a set of 3PL entities 104. Each of the set of shipper entities 105 may be a company, corporation, business, entity, individual, group of individuals, and/or the like that may manufacture, supply, or otherwise have access to physical goods, supplies, materials, animals, and/or other items (generally, “physical goods”) capable of being physically transported. Generally, each of the set of shipper entities 105 may intend to have transported a set of physical goods from an origin location to a destination location, where the set of physical goods may have an associated weight, dimensions, and/or other parameters. It should be appreciated that various numbers of the shipper entities 105 are envisioned.

Each of the 3PL entities 104 may be a third-party provider that the set of shipper entities 105 may use to outsource certain elements associated with handling and managing the transportation of the physical goods. In some embodiments, one or more of the shipper entities 105 may include one or more of the 3PL entities 104 (or vice-versa). The set of 3PL entities 104 may manage the fulfillment of shipping requests that originate from the set of shipper entities 105. Generally, each of the set of 3PL entities 104 may manage operation, warehousing, and transportation services which may be scaled and customized to customers' needs based on certain market conditions, such as the demands and delivery requirements for products and materials, and may manage one or more particular functions within supply management, such as warehousing, transportation, or raw material provision. Each of the set of 3PL entities 104 may be a single service or may be a system-wide bundle of services capable of managing various aspects of a supply chain (e.g., transportation of physical goods). It should be appreciated that various amounts of the 3PL entities 104 are envisioned.

The system 100 may further include a set of carrier entities (as shown: carrier A 111, carrier B 112, and carrier C 113). Each of the carrier entities 111, 112, 113 may be a company, corporation, business, entity, individual, group of individuals, and/or the like that owns or otherwise has access to a set of vehicles capable of transporting physical goods. According to embodiments, the transportation of goods may be accomplished via marine or water (i.e., using boats or ships), air (i.e., using aircraft), rail (i.e., using trains), or road (i.e., using trucks, cars, or other land-based vehicles). The term “vehicle,” as used herein, may refer to any vessel or craft capable of transporting goods via marine or water, air, rail, and/or road. The shipments of the goods may be categorized differently. Generally, freight shipments may be specific to trucks and may be categorized as less than truckload (LTL) or truckload (TL). Typically, but not always, LTL shipments may range from fifty (50) to seven thousand (7,000) kg in weight and 2.5 to 8.5 m in dimension, where trailers used in LTL shipments may range from 8.5 to 16.5 m, and where the shipments may be palletized, shrink-wrapped, and packaged. TL shipments are typically, but not always, larger than 7,000 kg, and may consist of physical goods that may be shipped using a single loaded truck.

The set of shipper entities 105 and the set of 3PL entities 104 may interface and communicate with a transportation management system (TMS) 106. According to embodiments, the TMS 106 may be any of a general transportation management system, warehouse management system (WMS), order management system (OMS), enterprise resource planning (ERP) system, or otherwise a system that may be used to manage freight. Generally, the TMS 106 may at least partly facilitate shipping agreements between the set of shipper entities 105 and the set of carrier entities 111, 112, 113, where the TMS 106 may facilitate route planning and optimization, load optimization, execution, freight audit and payment, yard management, advanced shipping, order visibility, and carrier management. The TMS 106 may be an open-source system or may be proprietary to any of the set of shipper entities 105 or the set of 3PL entities 104. According to embodiments, the TMS 106 may support specific and particular communication capabilities with the other entities of the system 100. In particular, the TMS 106 may support communication with the other entities via different components and protocols.

As illustrated in FIG. 1A, the system 100 may include a server 109 that may interface and communicate with at least the TMS 106, the set of carrier entities 111, 112, 113, and a set of computing devices 115. The server 109 may include any combination or hardware and software components, and may be associated with any type of entity or individual. The server 109 may support execution of a policy analysis module 110. According to embodiments, the policy analysis module 110 may receive tracking data associated with a shipping agreement and/or user location data associated with a shipper entity 105, 3PL entity 104, carrier entities 111, 112, 113, and/or other interested parties. In some implementations, the policy analysis module 110 further receives policies and/or policy data associated with shipment regions, tenants (e.g., shipper entity 105, 3PL entity 104, carrier entities 111, 112, 113, etc.), and/or modes, and determines, by analyzing the tracking data, the policy data, user location data, etc., whether one or more policies apply to tracking data for a particular user as discussed further herein. In some implementations, upon determining that one or more policies apply to the tracking data, the policy analysis module 110 obfuscates some or all of the tracking data before the data is transferred and/or displayed to the user in question. The policy analysis module 110 may interface with a database 108 or other type of memory configured to store data accessible by the policy analysis module 110.

The set of computing devices 115 may enable users access to a dashboard, interface, or the like that may include data that the policy analysis module 110 deems permissible and/or obfuscated data, as determined by the policy analysis module 110. In embodiments, the set of computing devices 115 may be associated with one or more of the shipper entities 105. Accordingly, the set of computing devices 115 may interface with the server 109 and/or the shipper entities 105.

Although FIG. 1A depicts the server 109 in communication with the TMS 106 and the set of carrier entities 111, 1112, 113, it should be appreciated that alternative configurations are envisioned. In one particular implementation, the TMS 106, the 3PL entity 104, and the server 109 may be combined as a single entity (i.e., the server 109 may communicate directly with the shipper entities 105 and the set of carrier entities 111, 112, 113). In another implementation, either the TMS 106 or the 3PL entity 104 may be combined with the server 109 as a single entity capable of performing the respective functionalities. Similarly, although FIG. 1A depicts the computing device 115 in communication with the shipper entities 105 and server 109, the computing device(s) 115 may further be in communication with the 3PL entities, the set of carrier entities 111, 112, 113, and/or further entities. As such, it should be appreciated that alternative configurations are envisioned

Although not depicted in FIG. 1A, the system 100 may support one or more computer networks that may enable communication between and among the entities and components of the system 100. In embodiments, the computer network(s) may support any type of wired or wireless data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). For example, the set of shipper entities 105 and the computing device(s) 115 may communicate with the TMS 106 (and/or with the policy analysis module 110) via an Internet connection.

It should be appreciated that the components and entities of the system 100 may include and support various combinations of hardware and software components capable of facilitating several of the functionalities of the systems and methods. For example, the components and entities of the system 100 may generally support one or more computer processors, communication modules (e.g., transceivers), memories, and/or other components.

FIG. 1B depicts an example environment 150 in which input data 117 is processed into output data 151 via an analysis platform 155, according to embodiments. The analysis platform 155 may be implemented on any computing device or combination of computing devices, including the server 109 as discussed with respect to FIG. 1A. Components of the computing device may include, but are not limited to, a processing unit (e.g., processor(s) 156), a system memory (e.g., memory 157), and a system bus 158 that couples various system components including the memory 157 to the processor(s) 156. In some embodiments, the processor(s) 156 may include one or more parallel processing units capable of processing data in parallel with one another. The system bus 158 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The analysis platform 155 may further include a user interface 153 configured to present content (e.g., input data, output data, processing data, and/or other information). Additionally, a user may review information and/or a dashboard compiled via a policy analysis and make selections to the presented content via the user interface 153, such as to review the dashboard presented thereon, make selections, and/or perform other interactions. The user interface 153 may be embodied as part of a touchscreen configured to sense touch interactions and gestures by the user. Although not shown, other system components communicatively coupled to the system bus 158 may include input devices such as cursor control device (e.g., a mouse, trackball, touch pad, etc.) and keyboard (not shown). A monitor or other type of display device may also be connected to the system bus 158 via an interface, such as a video interface. In addition to the monitor, computers may also include other peripheral output devices such as a printer, which may be connected through an output peripheral interface (not shown).

The memory 157 may include a variety of computer-readable media. Computer-readable media may be any available media that can be accessed by the computing device and may include both volatile and nonvolatile media, and both removable and non-removable media. By way of non-limiting example, computer-readable media may comprise computer storage media, which may include volatile and nonvolatile, removable and non-removable media implemented in any method or technology for storage of information such as computer-readable instructions, routines, applications (e.g., a policy analysis application 160) data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the processor 156 of the computing device.

The analysis platform 155 may operate in a networked environment and communicate with one or more remote platforms, such as a remote platform 165, via a network 162, such as a local area network (LAN), a wide area network (WAN), or other suitable network. The platform 165 may be implemented on any computing device, including any of the set of computing devices 115 as discussed with respect to FIG. 1A, and may include many or all of the elements described above with respect to the platform 155. In some embodiments, the policy analysis application 160 as will be further described herein may be stored and executed by the remote platform 165 instead of by or in addition to the platform 155.

Generally, each of the input data 117 and the output data 152 may be embodied as any type of electronic document, file, template, etc., that may include various graphical/visual and/or textual content, and may be stored in memory as program data in a hard disk drive, magnetic disk and/or optical disk drive in the analysis platform 155 and/or the remote platform 165. The analysis platform 155 may support one or more techniques, algorithms, or the like for analyzing the input data 117 to generate the output data 151. In particular, the policy analysis application 160 may analyze tracking data, user data, policy data, and/or other parameters associated with agreement shipment to determine whether any policies apply to shipment data for a particular user. Based on the analysis, the policy analysis application 160 may obfuscate some or all of the output data (i.e., the output data 151) that a user interface 153 displays to a user. Additionally, the policy analysis application 160 may generate multiple sets of output data, each set of output data obfuscated depending on the user for which the set of output data is intended. For example, the policy analysis application 160 may generate three sets of output data (e.g., copies) for entities A, B, and C. No policies apply to entity A, policies preventing precise location data apply to entity B, and policies preventing any location data apply to entity C. As such, the policy analysis application 160 generates the output data 151 such that the copy for each respective entity obfuscates the necessary data. The memory 157 may store the output data 151 and other data that the analysis platform 155 generates or uses in associated with the analysis of the input data 117.

According to embodiments, the policy analysis application 160 may employ machine learning and artificial intelligence techniques such as, for example, a regression analysis (e.g., a logistic regression, linear regression, random forest regression, probit regression, or polynomial regression), classification analysis, k-nearest neighbors, decisions trees, random forests, boosting, neural networks, support vector machines, deep learning, reinforcement learning, Bayesian networks, or the like. When the input data 117 is a training dataset, the policy analysis application 160 may analyze/process the input data 117 to generate a machine learning model(s) for storage as part of model data 163 that may be stored in the memory 157. In some implementations, the policy analysis application 160 uses machine learning and/or artificial intelligence techniques as described above to detect an anomaly and/or determine if a policy applies to particular shipment data for a user. For example, a policy may apply when the policy analysis application 160 detects an anomaly such as a number of shipping accidents, detected shipping inaccuracies, etc.

In further implementations, the policy analysis application 160 trains the machine learning model(s) that are stored as part of model data 163. For example, after receiving input data 117 and detecting the presence of an anomaly or determining to obfuscate data, the policy analysis application 160 may subsequently update the machine learning model(s) stored in model data 163. Depending on the implementation, the input data 117 may be labeled (e.g., the policy analysis application 160 trains the machine learning model(s) using supervised machine learning techniques) or unlabeled (e.g., the policy analysis application 160 trains the machine learning model(s) using unsupervised machine learning techniques). As such, the policy analysis application 160 may further improve the machine learning model(s) stored in model data 163 and improve the overall functionality of the system.

The policy analysis application 160 (or another component) may cause the output data 151 (and, in some cases, the input data 117) to be displayed on the user interface 153 for review by the user of the analysis platform 155. Additionally, the policy analysis application 160 may analyze or examine the output data 151 to confirm that information, which may be displayed on the user interface 153 as part of a dashboard, interface, or the like, is properly obfuscated before displaying to a user.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 156 (e.g., working in connection with an operating systems) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML, R, Stata, AI libraries). In some embodiments, the computer program product may be part of a cloud network of resources.

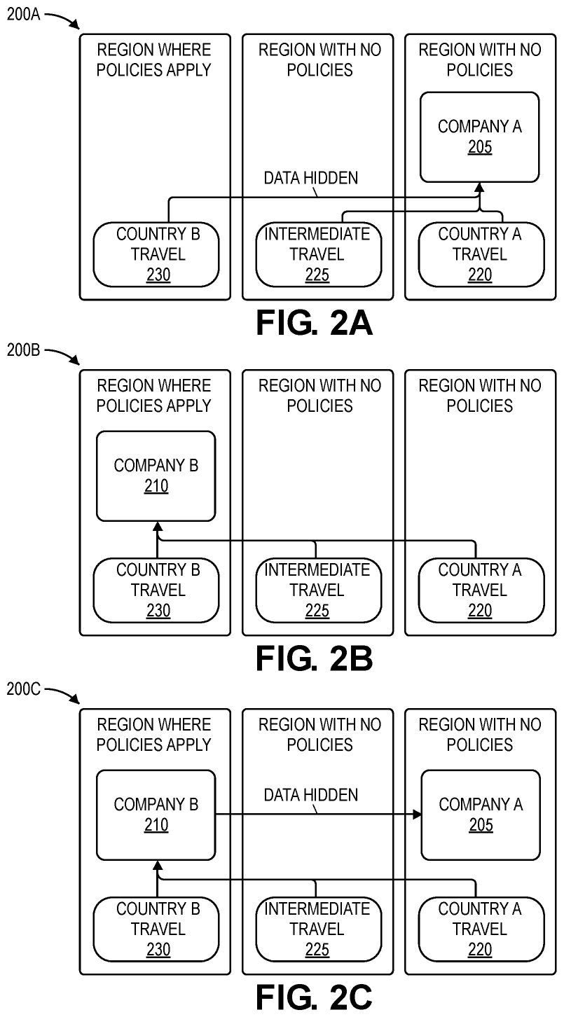

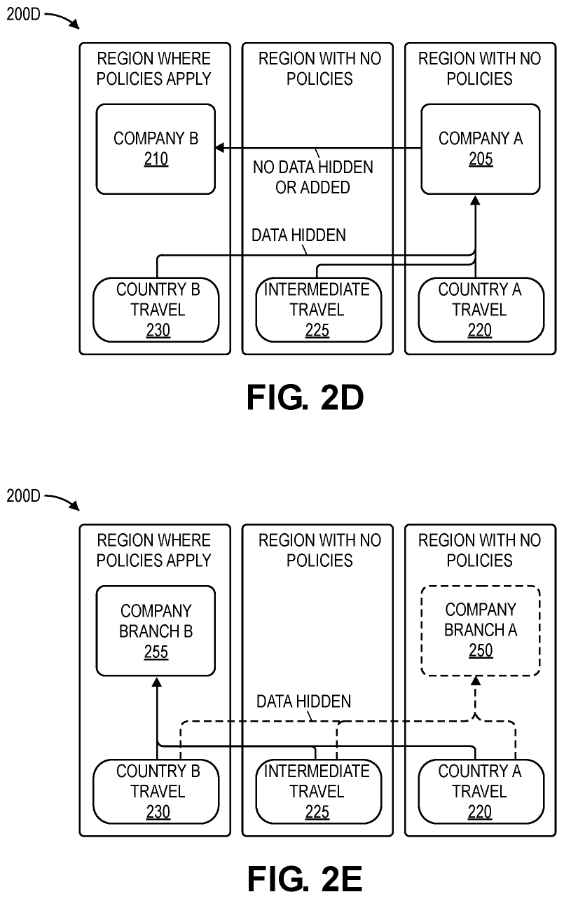

FIGS. 2A-2E depict block diagrams of exemplary scenarios 200A, 200B, 200C, 200D, and 200E for an electronic device (e.g., the server 109) to determine what data of the shipment tracking data to obfuscate and for which users. FIG. 2A depicts a scenario 200A in which a company 205 (as shown: “Company A”) located in country A has a shipment that travels through regional transport phases including at least: (i) country A travel 220, (ii) country B travel 230, in which regional policies apply to the company 205, and (iii) intermediate region travel 225, in which regional policies do not apply to the company 205. In the example of scenario 200A, the electronic device allows for country A travel 220 data and intermediate travel 225 data to reach company A 205 without obfuscation. However, because the regional policies for country B require that the electronic device obfuscate data regarding country B travel 230 for company A 205, the electronic device obfuscates the data before company A 205 views the information.

FIG. 2B depicts an additional scenario 200B in which a company 210 (as shown: “Company B”) located in country B has a shipment that travels through regional transport phases including at least: (i) country A travel 220, in which no regional policies apply to the company 210 (ii) country B travel 230, and (iii) intermediate region travel 225, in which regional policies do not apply to the company 205. In the example of scenario 200B, the electronic device allows for country A travel 220 data, country B travel 230 data, and intermediate travel 225 data to reach company B 210 without obfuscation, as country A and the intermediate travel regions have no policies, and country B has policies that do not apply to company B 210, as company B 210 is located in country B.

FIG. 2C depicts an additional scenario 200C in which company B 210 located in country B passes information to the company A 205 located in country A. In the example of scenario 200C, company B 210 does not trigger the regional policy for country B because the company B 210 is located in country B. Similarly, other regions through which the shipment travels do not have policies that apply to country B. As such, company B receives the data regarding country A travel 220, intermediate travel 225, and country B travel 230 without obfuscation. However, because country A does trigger a policy, the electronic device obfuscates the country B travel 230 data after company B 210 receives the data, but before company A 205 receives the data in question. In some implementations, the electronic device obfuscates all data that would potentially violate the policy (e.g., all location data). In further implementations, the electronic device obfuscates only the data directly confirmed to violate the policy in question (e.g., location data for country B travel 230).

FIG. 2D depicts another additional scenario 200D similar to scenario 200C, but in which company A 205 located in country A passes information to the company B 210 located in country B. In the example of scenario 200D, company A 205 triggers the regional policy for country B, but company B 210 does not. As such, company A 205 receives an obfuscated version of the data regarding country A travel 220, intermediate travel 225, and country B travel 230. The company A 205 may then transmit the obfuscated data to the company B 210. Depending on the implementation, the data may be permanently obfuscated such that company B 210 does not see the hidden data or such that company B 210 sees the hidden data while company A 205 does not, as described herein. In further implementations, company B 210 does not see any data added by company A 205.

FIG. 2E depicts yet another scenario 200E in which two branches of a company located in countries A and B (company branch A 250 and company branch B, respectively) receive data regarding the shipment. Because company branch A 250 is located in country A, the company branch A receives data regarding country A travel 220 and intermediate travel 225 without obfuscation, but receives data regarding country B travel 230 that the electronic device obfuscates, even though company branch B 255 receives the country B travel 230 data without obfuscation.

It will be understood that other potential scenarios are envisioned. For example, although scenarios 200A-200E only depict three sets of travel data, an embodiment may include a set of travel data for each individual region, or may include two categories of “obfuscated” travel data and “non-obfuscated” travel data. Other embodiments are therefore envisioned consistent with the disclosure herein.

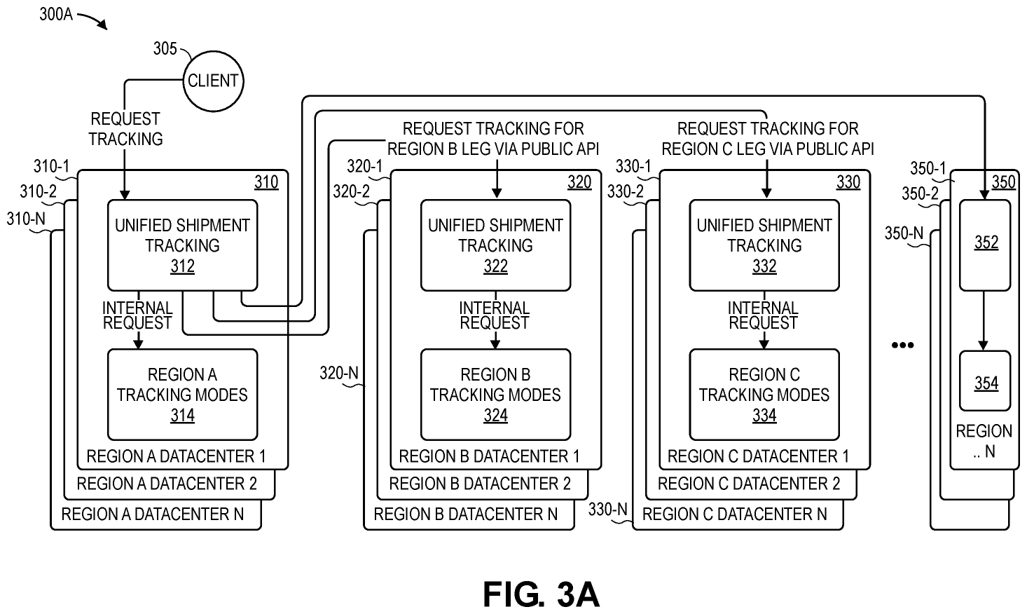

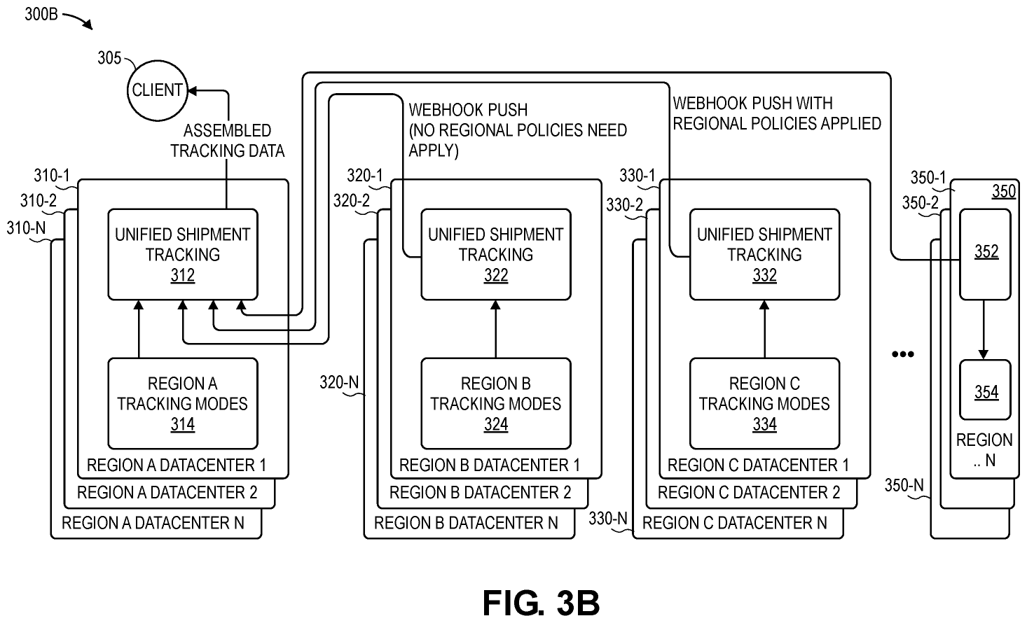

FIG. 3A depicts a scenario 300A for initiating tracking across multiple regions. In some implementations, a client 305 transmits a tracking request to a datacenter 310. Depending on the implementation, the datacenter 310 may be a datacenter located in the same region as the client 305, such as region A. In further implementations, the datacenter 310 may be a first datacenter 310-1 of a region out of some number N datacenters, 310-1-310-N(also collectively referred to as “datacenters 310”). In some such implementations, the datacenter 310-1 is the datacenter located physically closest to the client 305, a client-chosen datacenter, a random datacenter of the set of datacenters 310, etc.

In some implementations, the datacenter 310-1 receives the tracking request at a unified shipment tracking module 312. The unified shipment tracking module 312 then, depending on the implementation determines the regions to which the unified shipment tracking module 312 should distribute the request for tracking. In some implementations, the client 305 includes information regarding which regions should request tracking in the initial request for tracking and the unified shipment tracking module 312 automatically forwards the request on to the appropriate region datacenters. In further implementations, the unified shipment tracking module 312 determines the regions by analyzing the tracking request and/or transmitting an additional request for information on the tracking route. After determining the proper regions, the unified shipment tracking module 312 transmits the request for tracking to datacenters 320, 330, 350, etc. for each appropriate region. Similar to datacenter 310, each of the datacenters may be one of multiple data centers (e.g., datacenters 320-1-320-N, 330-1-330-N, 350-1-350-N, etc.). Each set of datacenters receives the request at a respective unified shipment tracking module (e.g., unified shipment tracking module 322 for region B, 332 for region C, etc. through unified shipment tracking module 352 for an Nth region).

In some implementations, in addition or alternatively to transmitting the request for tracking to each determined region, the unified shipment tracking module 312 transmits a request to region A tracking modes 314, which handle tracking and/or receiving tracking data for the shipment within the region A. In some implementations, each datacenter 310-1-310-N in a region has a separate set of region A tracking modes. In some such implementations, the set of region A tracking modes 314 in the same datacenter 310-1 as the unified shipment tracking module 312 consolidates information from the tracking modes. Similarly, each of unified shipment tracking modules 322, 332, 352, etc. transmits similar requests to region B tracking modes 324, region C tracking modes 334, etc. through tracking modes 354 for the Nth region. Depending on the implementation, the region B tracking modes 324, region C tracking modes 334, tracking modes 354, etc. behave similarly to the region A tracking modes 314.

FIG. 3B depicts a scenario 300B for assembling and providing tracking data from across multiple regions to a client, using a similar architecture as described above with regard to FIG. 3A. In some implementations, each unified shipment tracking module 312, 322, 332, 352, etc. receives information from the respective region tracking modes 314, 324, 334, 354, etc. Depending on the implementation, a unified shipment tracking module for each region (e.g., unified shipment tracking modules 322, 332, 352, etc.) assembles and transmits the data to the unified shipment tracking module 312 for region A. The unified shipment tracking module 312 then assembles all of the tracking data and transmits the assembled tracking data to the client 305.

In some implementations, each unified shipment tracking module 312, 322, 332, 352, etc. obfuscates any data according to regional policies before transmitting the data. In other implementations, the unified shipment tracking module 312 for region A obfuscates the data depending on from which region the respective tracking data arrives. In further implementations, each unified shipment tracking module 312, 322, 332, 352, etc. communicates with each other via webhook push with regional policies, webhook push without regional policies, public API, etc.

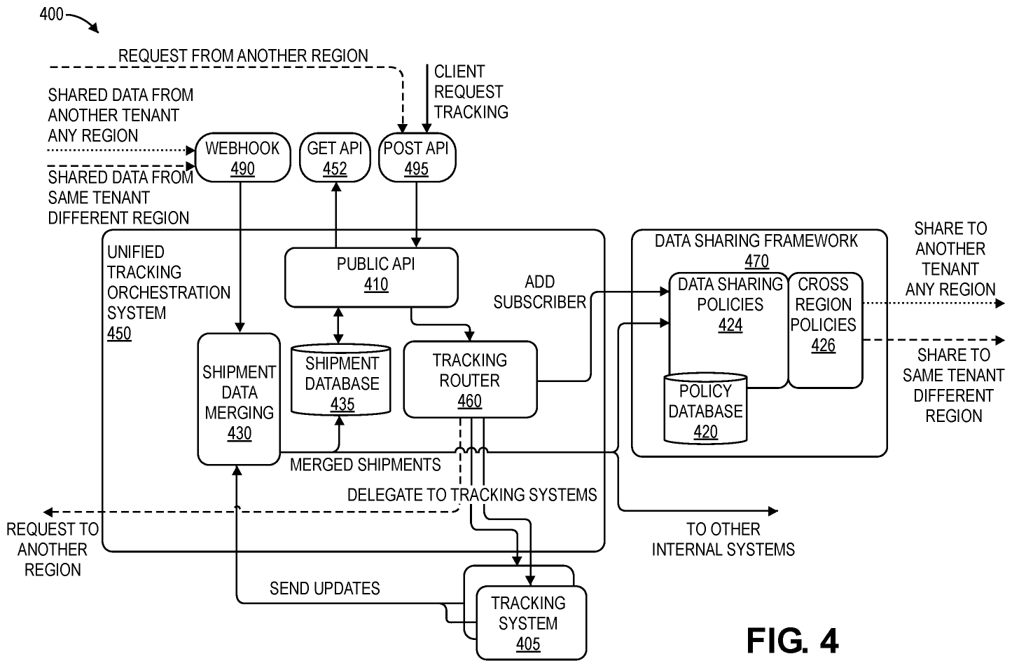

FIG. 4 depicts an exemplary system 400, which may be used in conjunction with and/or to perform the techniques as discussed herein. In the system 400, a unified tracking orchestration system (also referred to as a “unified system”) 450 communicates with one or more tracking systems 405, a data sharing framework 470, and/or other regional tracking systems. Depending on the implementation, the unified system 450 and/or tracking systems 405 may be or include unified shipment tracking module 312 and/or tracking modes 314 from FIGS. 3A and 3B. In further implementations, the unified system 450 and/or tracking systems 405 are communicatively coupled with the unified shipment tracking module 312 and/or tracking modes 314 from FIGS. 3A and 3B.

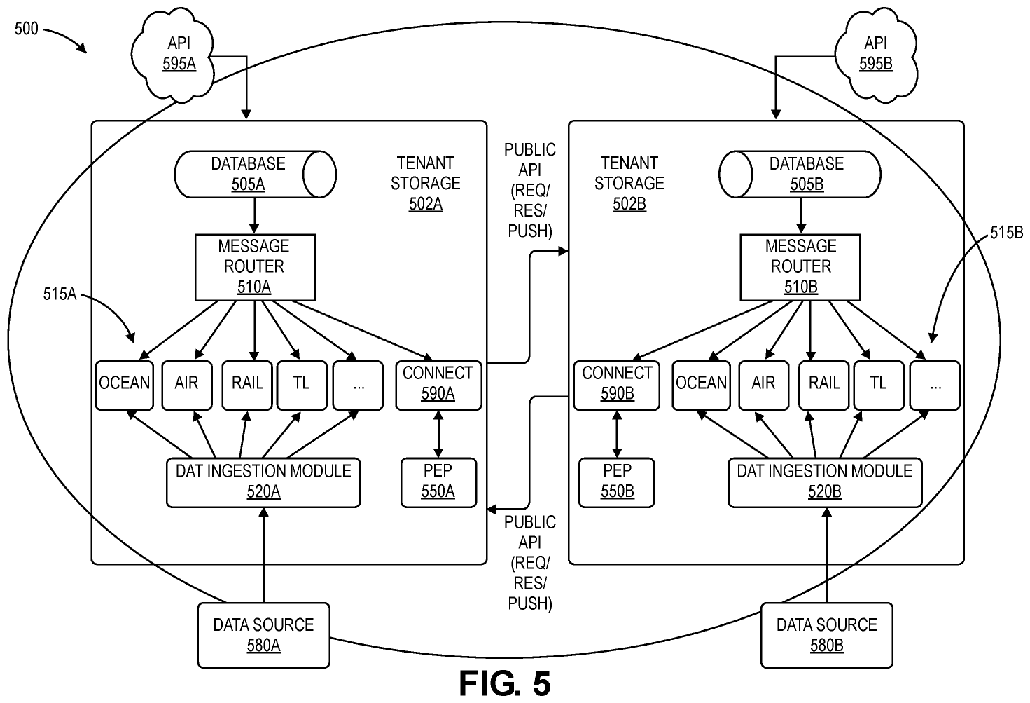

In some implementations, the unified system 450 receives a client request for tracking at a public API 410 via a post API 495. In further implementations, the unified system 450 requests additional information from a client or another system via a retrieval API (such as a Get API) 452. Although FIG. 4 illustrates an example using APIs, it will be understood that, depending on the implementation, the unified system 450 may receive a client request via APIs, webhooks, web services, etc. Depending on the implementation, the client request for tracking may also include user characteristic data, an indication of a user profile as described herein with regard to FIG. 5, etc.

After receiving the client request, the public API 410 communicates with a tracking router 460 that determines which regions a shipment will pass through, and delegates tracking the shipment to various tracking systems 405 and/or other regional unified tracking systems, similar to unified system 450. Depending on the implementation, the tracking router 460 may determine which regions the shipment will pass through based on an analysis of the client request as described herein, based on one or more parameters or flags in the client request, based on other information transmitted or retrieved in response to the client request, etc.

In some implementations, the tracking router 460 determines to transmit the request to track the shipment to other regional tracking systems, similar to unified system 450, via a webhook, API, web service, etc. Depending on the implementation, the tracking router 460 may additionally add a subscriber for the information based on the client request and transmit subscriber information to a data sharing framework 470.

In further implementations, the data sharing framework 470 receives an indication of an additional subscriber from tracking router 460. The data sharing framework 470 may then determine and retrieve data sharing policies 424 and/or cross region policies 426 from a policy database 420 for the subscriber. Depending on the implementation, the data sharing policies 424 include tenant-to-tenant policies when the relevant tenant is in the same region as the subscriber. In further implementations, the data sharing policies 424 or cross region policies 426 may be for a particular subset of a region and may apply to a subscriber accordingly. In implementations in which the subscriber is located in another region or a shipment includes another tenant, the data sharing framework 470 may share the policies with the respective regional tracking system.

In some implementations, a shipment data merging module 430 (also referred to as “merging module” 430) receives data and/or updates regarding tracking for a shipment from the tracking systems 405. In further implementations, the merging module 430 additionally or alternatively receives information from other tenants and/or regions via a webhook 490.

Depending on the implementation, the data received at the merging module 430 may include data regarding various regions through which the shipment travels, current status of a shipment, current location of a shipment, user characteristic data, shipment data, travel data, etc. as described herein. In further implementations, the tracking system(s) 405 include or are user profiles associated with a circle of trust and/or are authenticated as described herein with regard to FIG. 5. Depending on the implementation, the tracking system(s) 405 gather and/or normalize data from entities prior to transmitting the data to the merging module 430.

In some implementations, the merging module 430 receives information regarding data sharing policies or cross region policies from a data sharing framework similar to data sharing framework 470. In some such implementations, the merging module 430 determines whether to obfuscate the data according to the received policy data. Depending on the implementation, the merging module 430 may obfuscate the data or send it to an obfuscation module (not shown) that handles the obfuscation. Similarly, in other implementations, the merging module 430 transmits the data to another module (not shown) that determines whether the data should be obfuscated.

The merging module 430 may then transmit data to the data sharing framework 470, which may use the data to determine what data sharing policies 424 or cross region policies 426 may apply to the shipment. Similarly, the merging module 430 may transmit data to other internal systems in the system 400.

FIG. 5 depicts a block diagram of an exemplary circle of trust 500. In some implementations, the circle of trust 500 includes one or more tenant storages 502A and/or 502B that store information about a user, such as a user profile including user characteristic data. Depending on the implementation, the circle of trust 500 stores a list of tenants and region(s) associated with each tenant. As such, each tenant storage 502 is associated with a different tenant, and each associated user profile includes information regarding tenant policies for the respective user, a user location for the respective user, types of products shipped by the respective user, etc. Depending on the implementation, the circle of trust 500 authenticates the data in the user profile upon profile creation and/or update. In some implementations, the circle of trust 500 authenticates the data using OAUTH trust validation to confirm the information using other user accounts. In further implementations, the circle of trust 500 authenticates the data using an authenticator application, a FIDO2 security key, SMS authentication, voice authentication, password authentication, OATH tokens, etc.

In some implementations, the information about the user is stored in the database 505A and/or 505B. In some implementations, the database 505A and/or 505B is a Kafka database, a centralized database, a cloud database, a NoSQL database, an object-oriented database, or any similar database. Further, a system such as the systems 400A and/or 400B as described in FIG. 4 above may access the tenant storages 502A and/or 502B using an API 395A and/or 395B. In some implementations, tenant storage 502A and tenant storage 502B are associated with the same tenant, and instead include regional differences and/or regional data associated with the tenant. For example, tenant storage 502A may store information related to US operations for a user while tenant storage 502B stores information related to Chinese operations for the user.

In some implementations, a data ingestion module 520A and/or 520B queries and gathers information from a data source 580A and/or 580B. Depending on the implementation, the data source 580A and/or 580B can be a carrier, a supplier, a company, etc. The data source 580A and/or 580B may include a smart device or other device that gathers and transmits telematics data regarding a user or a shipment. The data ingestion module 520A and/or 520B then separates the data from the data source 580A and/or 580B into travel categories 515A and/or 515B. Depending on the implementation, the travel categories 515A and/or 515B may include ocean travel, air travel, rail travel, truckload travel, etc. A message router 510A and/or 510B then updates the categories with information from the database 505A and/or 505B, and transmits messages to the connection module 590A and/or 590B regarding the travel information. Depending on the implementation, the connection module 590A and/or 590B may share information with another tenant storage 502B and/or 502A via a public API (e.g., via a request, response, and/or push operation), and/or with a policy enforcement point (PEP) 550A and/or 550B. In some implementations, the PEP 550A and/or 550B then applies policies to and/or obfuscates the information as described herein.

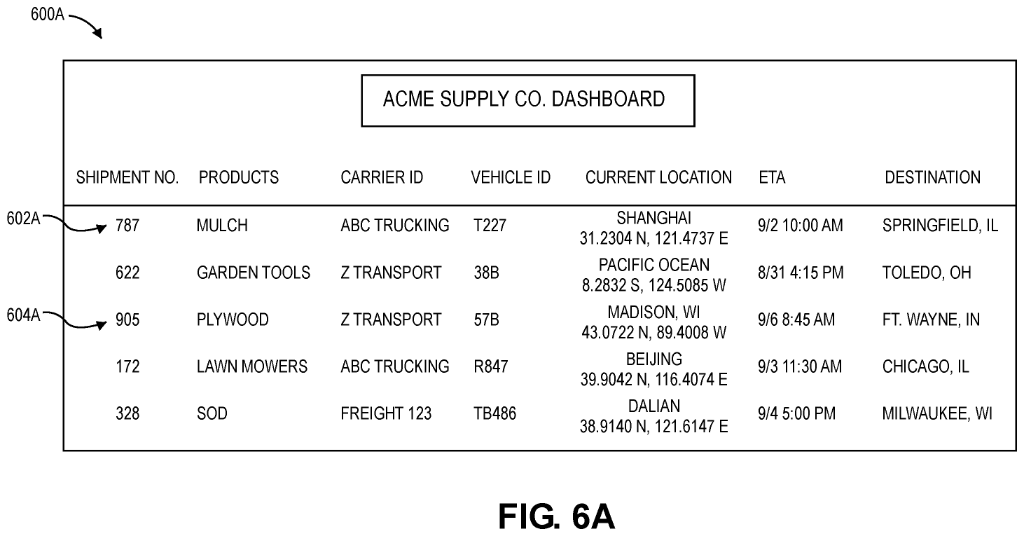

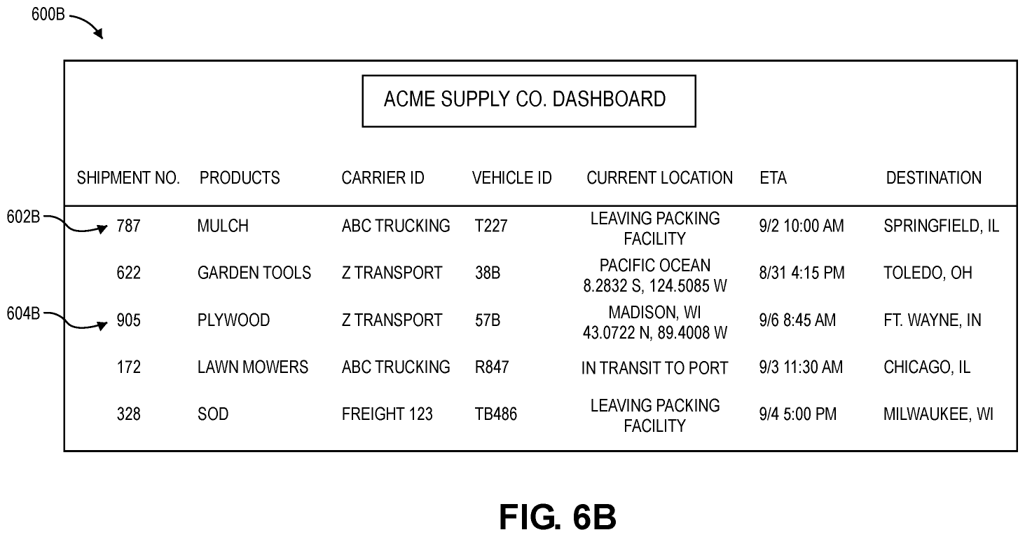

FIGS. 6A and 6B are example interfaces 600A and 600B (collectively referred to as interface 600) associated with an example shipper entity (as shown: “Acme Supply Co.”). FIG. 6A illustrates an example embodiment in which the example shipper entity does not trigger any regional policies as described in FIG. 4 above (as shown, the example shipper entity is located in China). FIG. 6B illustrates an example embodiment in which the example shipper entity does trigger a regional policy as described in FIG. 4 above (as shown, the example shipper entity is located in the United States of America).

According to some embodiments, a user associated with the shipper entity may use a computing device to access the interface 600. Additionally, a server (e.g., the server 109) may generate or determine the information included in the interface 600, as discussed herein. It should be appreciated that the interface 600A and interface 600B are merely examples, and that additional or alternative information is envisioned.

Generally, the interface 600 may indicate current shipping agreements that the shipper entity has with various carrier entities. The interface 600 may include, for each shipping agreement, the following information: shipment number, products being transported, carrier identification, vehicle identification, current location of the vehicle, an estimated time of arrival for the shipment, and a destination. In some implementations, the interface 600A displays the current location of the vehicle using specific information, such as a city, state, region, country, and/or latitude and longitude of the vehicle. Depending on the implementation, the interface 600B instead obscures the location data in accordance with a shipping policy, such as a region policy, a tenant policy, a mode policy, etc., as described herein at least with regard to FIGS. 4, 7, and 8. In some such implementations, the interface 600B obscures the location data by displaying aggregated information as a milestone rather than specific location data.

Although FIG. 6B illustrates an embodiment in which the interface 600B displays milestone information to obscure the location information, it will be understood that other methods for obscuring information are also envisioned. For example, in some implementations, the interface 600B displays information where permissible according to shipping policies, but otherwise redacts information prohibited by the shipping policies, such as by displaying an opaque line and/or box that covers the location data when viewed by a user not permitted to view the data according to the shipping policies. In further implementations, the interface 600B omits the location column entirely, displays a message noting which policies prohibit the display of the displays a simplified or modified view, or otherwise obscures the information prohibited by the shipping policies.

The interface 600A enables the user to review information and assess current locations of vehicles and estimated times of arrivals for multiple shipments across multiple carriers. For example, row 602A of the interface 600A indicates shipment number 787 that corresponds to ABC Trucking transporting mulch on vehicle ID T227 at a current location in Shanghai, China with approximate coordinates of 31.4304 N and 121.4737 E, and with an ETA of September 2 in Springfield, IL at 10:00 AM. The same row 602B displays the same information but obscures at least part of the information as described above. In the example of FIG. 6B, row 602B of the interface 600B indicates shipment number 787 that corresponds to ABC Trucking transporting mulch on vehicle ID T227, to arrive in Springfield, IL at 10:00 AM with an ETA of September 2 in Springfield, IL at 10:00 AM. However, the location data is obscured—rather than showing the location, the interface 600B displays a milestone instead, noting that the shipment is leaving the packing facility.

In contrast, rows 604A and 604B of the interfaces 600A and 600B, respectively, display the same information. In particular, both rows 604A and 604B indicate shipment number 405 that corresponds to Z Transport transporting plywood on vehicle ID 57B at a current location in Madison, WI with coordinates 43.0722 N and 89.2008 W, and with an ETA of September 6 in Fort Wayne, IN at 8:45 AM. As such, a user located in, for example, the United States of America is only able to see location data allowed by shipping policies while location data that is not allowed, such as precise location data in China, is instead replaced with aggregated milestone data.

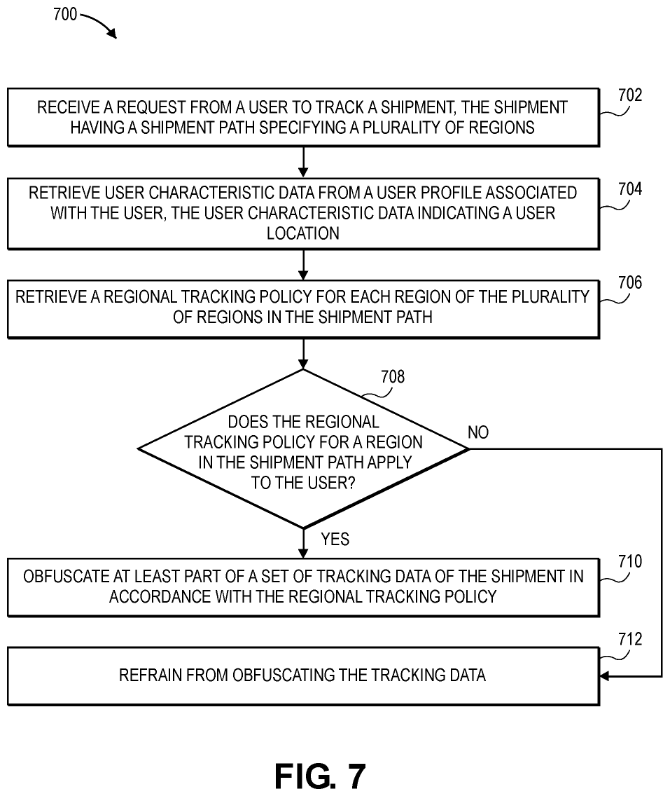

FIG. 7 depicts a block diagram of an example method 700 of tracking and sharing shipment data in accordance with one or more shipping policies. The method 700 may be facilitated by an electronic device (such as the server 109 as depicted in FIG. 1A). In embodiments, the electronic device may communicate with a set of data sources and a set of computing devices.

The method 700 may begin when the electronic device receives (block 702) a request from a user to track a shipment. Depending on the implementation, the shipment has a shipment path that specifies the region(s) through which the shipment is to travel. In some implementations, the request from the user to track the shipment is an implicit request. For example, the electronic device may determine that a shipment request automatically includes a request to track the shipment. In further implementations, the request is explicit, such as in response to a notification from a user and/or a user clicking on a link or button associated with an application.

The electronic device then retrieves (block 704) user characteristic data from a user profile associated with the user, the user characteristic data indicating a user location. In some implementations, the user characteristic data and/or the user profile is part of a circle of trust as described above at least with regard to FIG. 5. In some such implementations, the electronic device authenticates the user location in response to determining that the user profile is associated with the set of trusted users, such as via OAUTH, passkeys, or another, similar authentication method. Depending on the implementation, the electronic device authenticates the user location when the user profile is created and/or updated, and instead confirms the user location with the authenticated user location. In further implementations, the electronic device determines a different user location based on shipping data associated with the shipment. In some such implementations, the electronic device determines whether to use the user location associated with the shipment or associated with the user profile based on whether the user profile is part of the circle of trust.

The electronic device then retrieves (block 706) a regional tracking policy for each region in the shipment path. Based on the regional tracking policy for each region, the electronic device determines (block 708) whether a policy for a given region in the shipment path applies to the user. In some implementations, the electronic device applies each regional tracking policy to the shipment immediately after retrieving the policy in question, as described above in one embodiment with regard to FIG. 4. In other implementations, the electronic device assembles the regional tracking policies into an overall shipping tracking policy before applying the entire policy to the shipment, as described above in another embodiment with regard to FIG. 4.

If a regional tracking policy does apply, then the electronic device obfuscates (block 710) at least part of a set of tracking data for the shipment in accordance with the regional tracking policy. For example, a regional tracking policy for China may require that particular location data is not to be shared with users located outside of China. A user in the US causes the regional tracking policy for China to apply, and the electronic device in the example obfuscates location data in China for the user in question. In some implementations, the electronic device obfuscates the tracking data by refraining from availing the tracking data in question for display in a user interface. Similarly, depending on the implementation, the data for the electronic device to obfuscate includes precise location data, personally identifiable information (PII) data, data regarding other tenants in the shipment, etc.

In some implementations, the electronic device obfuscates data according to a tenant-to-tenant policy. In such implementations, the electronic device obfuscates data regarding a first user (e.g., a tenant) for any other users in the shipment to which a tenant-to-tenant policy applies. For example, a user A may require a policy that location data of particular stops and/or item data for the tenant is to be obfuscated for other tenants in the same shipment. As such, the electronic device may obfuscate data regarding planned stops and/or what items user A has for the shipment for any users besides the user A. In some implementations, the electronic device automatically obfuscates personal data such as an end delivery location for all users other than the user in question.

In further implementations, the electronic device obfuscates the tracking data by redacting the data, displaying a message to the user indicating the electronic device will not display the data due to a policy, or otherwise refraining from displaying the data as described herein at least with regard to FIGS. 6A and 6B. If a regional tracking policy does not apply, then the electronic device refrains (block 712) from obfuscating the set of tracking data.

In some implementations, the electronic device determines that a user is attempting to, has attempted to, and/or will attempt to share shipping data with a second user associated with a second user profile in the circle of trust. Depending on the implementation, the first user and the second user are different regional branches of a company, each regional branch located in a different region in the shipment path. The electronic device then retrieves a second set of user characteristic data from a second user profile associated with the second user, including a second user location and determines, based on the second user location, whether any of the regional tracking policies for regions in the shipment path apply to the second user.

In some such implementations, the electronic device generates a copy for the second user and obfuscates the tracking data differently depending on which users are covered by the tracking policy. For example, in various implementations, the electronic device obfuscates the tracking data in accordance with the regional tracking policy for: (i) only the first user when the regional tracking policy applies to the first user but not the second, (ii) only the second user when the regional tracking policy applies to the second user but not the second, (iii) both the first user and the second user when the regional tracking policy applies to both users, (iv) both the first user and the second user when the regional tracking policy applies to either user, and/or (v) neither the first user nor the second user when the regional tracking policy applies to neither user. In other implementations, the electronic device obfuscates the tracking data in the original document appropriately at read-time and/or when a user is accessing the document. In such implementations, the electronic device filters and rewrites the copy after generation rather than filtering at read time. As such, the copy more securely obfuscates the information in question and prevents the need for repeated filtering operations at runtime.

In some implementations, the electronic device additionally or alternatively determines whether to obfuscate part of the set of tracking data based on other policies, such as tenant tracking policies, mode policies, etc. In such implementations, the electronic device retrieves a policy such as a tenant tracking policy or a mode policy from the proper database and determines whether the policy in question applies to the first and/or second user(s). The electronic device then obfuscates the relevant portion of the tracking data in accordance with the policy as described herein.

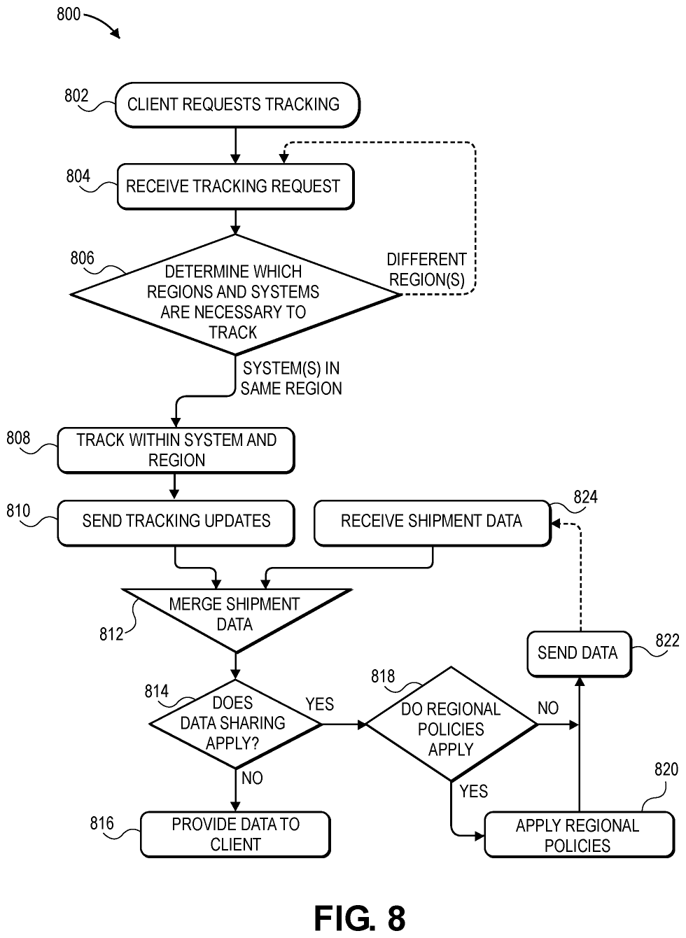

FIG. 8 depicts a block diagram of another example method 800 of tracking and sharing shipment data in accordance with one or more shipping policies. The method 800 may be facilitated by an electronic device (such as the server 109 as depicted in FIG. 1A). In embodiments, the electronic device may communicate with a set of data sources and a set of computing devices.

At block 802, a client requests tracking for a shipment. Depending on the implementation, the client may transmit the request to a unified tracking system and/or module on a datacenter as described in more detail with regard to FIGS. 3A-4. In some implementations, the client transmits the request via an API, a webhook, web services, etc. Depending on the implementation, the tracking request may include information such as client information, shipment information, tracking preferences, regional information, etc. At block 804, the electronic device receives the tracking request. In some implementations, the electronic device includes or is part of a regional datacenter, and the electronic device also receives information from other regional datacenters at block 804.

At block 806, the electronic device determines which regions and systems are necessary to track. In some implementations, the electronic device extracts information from the tracking request received at block 804 and makes the determination accordingly. In further implementations, the tracking request or additional information received at block 804 indicates what regions and systems are necessary and the electronic device makes the determination based on the direct information. When the electronic device determines to track other regions, the electronic device sends information to other regions and/or systems accordingly, and flow returns to block 804. When the electronic device determines to track within the same region, flow proceeds to block 808. Depending on the implementation, the electronic device may further determine to track within both the same region and different regions. In some such implementations, the electronic device may transmit information to other regions as necessary before continuing to track within the same region.

At block 808, the electronic device tracks the shipment in question within the region. In some implementations, the electronic device tracks the shipment by communicating with one or more tracking systems/modes, as described with regard to FIGS. 3A-4 above. At block 810, the electronic device sends tracking updates regarding the shipment. In some implementations, the tracking updates are between different datacenters of the same region. In further implementations, the tracking updates are between different modules of the same electronic device or datacenter.

At block 812, the electronic device merges shipment data. In some implementations, the electronic device merges shipment data from multiple regions and/or tenants. In further implementations, the electronic device merges shipment data from different tracking systems and/or datacenters within a region. At block 814, the electronic device determines whether data sharing applies. In some implementations, the electronic device determines that data sharing applies when the electronic device receives a transmission from other servers, datacenters, regions, etc. In further implementations, the electronic device determines that data sharing applies in response to determining that the merged shipment data includes data indicating the shipment includes items from multiple tenants, items that pass through multiple regions, etc. Depending on the implementation, the electronic device may determine that data sharing applies when one or more regional or tenant policies apply to the data and the data has not been obfuscated. In further implementations, the electronic device determines that data sharing does not apply if the electronic device has already obfuscated the data at least once. If data sharing does not apply, then flow continues to block 816, where the electronic device provides the data to the client. If data sharing does apply, then flow continues to block 818 instead.

At block 818, the electronic device determines whether regional policies apply to any of the merged shipment data for the client. In some implementations, the electronic device determines whether regional policies apply based on regional and/or location data for the client. In some such implementations, the electronic device retrieves the regional and/or location data for the client from a client profile, as described herein with regard to FIG. 5. If regional policies apply to the merged shipment data for the client, then flow continues to block 820 and then block 822. Otherwise, if regional policies do not apply to the merged shipment data, then flow continues directly to block 822 instead. At block 820, the electronic device applies the regional policies to the relevant data as described herein. At block 822, the electronic device transmits the data. In some implementations, the electronic device transmits the data directly to the client. In other implementations, the electronic device transmits the data internally to the module merging the shipment data or to another datacenter or server merging the shipment data.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

What is claimed is:

1. A method for tracking and sharing shipment data, the method comprising:
receiving, by one or more processors, a request from a user to track a shipment, the shipment having a shipment path specifying a plurality of regions;
retrieving, by the one or more processors, user characteristic data from a user profile associated with the user, the user characteristic data indicating a user location;
retrieving, by the one or more processors, a regional tracking policy for each region of the plurality of regions in the shipment path;
determining, by the one or more processors and based on the user location, whether the regional tracking policy for each region of the plurality of regions in the shipment path applies to the user; and
responsive to the determining whether the regional tracking policy for each region of the plurality of regions in the shipment path applies to the user:
obfuscating at least part of a set of tracking data of the shipment in accordance with the regional tracking policy when the regional tracking policy applies, including not availing the at least part of the set of tracking data for display in a user interface, and
refraining from obfuscating the set of tracking data when the regional tracking policy does not apply.

2. The method of claim 1, wherein the user profile associated with the user is further associated with a set of trusted users and further comprising:
responsive to determining that the user profile is associated with the set of trusted users, authenticating the user location.

3. The method of claim 1, wherein the user location is a first user location, the method further comprising:
determining, based on shipping data associated with the shipment, a second user location different than the first user location; and
determining whether to use the first user location or the second user location based at least in part on whether the user profile is associated with a set of trusted users.

4. The method of claim 1, wherein the user is a first user, the user characteristic data is a first set of user characteristic data, the user profile is a first user profile, and the user location is a first user location, the method further comprising:
determining that the first user shares the shipping data with a second user associated with a second user profile;
retrieving, by the one or more processors, a second set of user characteristic data from a second user profile associated with the second user, the second set of user characteristic data indicating a second user location;
determining, based on the second user location, whether the regional tracking policy for each region of the plurality of regions in the shipment path applies to the second user;
wherein the obfuscating includes:
obfuscating the at least part of the set of tracking data in accordance with the regional tracking policy for only the first user when the regional tracking policy applies to the first user and does not apply to the second user,
obfuscating at the least part of the set of tracking data in accordance with the regional tracking policy for only the second user when the regional tracking policy applies to the second user and does not apply to the first user, and
obfuscating at the least part of the set of tracking data in accordance with the regional tracking policy for the first user and the second user when the regional tracking policy applies to the first user and the second user; and
wherein the refraining from obfuscating includes:
refraining from obfuscating the set of tracking data when the regional tracking policy does not apply to the first user and the second user.

5. The method of claim 4, wherein the first user is a first regional branch of a company located in a first region of the plurality of regions and the second user is a second regional branch of the company located in a second region of the plurality of regions.

6. The method of claim 4, further comprising:
retrieving a tenant tracking policy for the first user;
determining whether the tenant tracking policy for the first user applies to the second user; and
responsive to the determining whether the tenant tracking policy for the first user applies to the second user:
obfuscating the at least part of the set of tracking data in accordance with the tenant tracking policy when the tenant tracking policy applies, and
refraining from obfuscating the set of tracking data when the tenant tracking policy does not apply.

7. The method of claim 4, further comprising:
rendering, using the set of tracking data, shipment information for the first user;
generating, based on the shipment information, a copy of the shipment information for the second user;
wherein obfuscating the at least part of the set of tracking data in accordance with the regional tracking policy for only the second user includes:
applying the obfuscating to the copy of the shipment information for the second user, and
wherein obfuscating the at least part of the set of tracking data in accordance with the regional tracking policy for the first user and the second user includes:
applying the obfuscating to the shipment information and the copy of the shipment information.

8. The method of claim 1, wherein the user is a first user of a plurality of users associated with the shipment, the method further comprising:
retrieving a tenant tracking policy for each of the plurality of users;
determining whether the tenant tracking policy for each of the plurality of users applies to the first user; and
responsive to the determining whether the tenant tracking policy for each of the plurality of users applies to the first user:
obfuscating the at least part of the set of tracking data in accordance with the tenant tracking policy when the tenant tracking policy applies, and
refraining from obfuscating the set of tracking data when the tenant tracking policy does not apply.

9. The method of claim 1, further comprising:
responsive to the retrieving the regional tracking policy for each region of the plurality of regions in the shipment path, assembling the regional tracking policy for each region of the plurality of regions into a shipping tracking policy; and
wherein the determining whether the regional tracking policy for each region of the plurality of regions in the shipment path applies to the user is responsive to the assembling.

10. The method of claim 1, wherein:
the obfuscating includes sharing an aggregate of shipping information with the user but not particular position data of the shipment, and
the refraining from obfuscating includes sharing the particular position data of the shipment with the user.

11. A computing system for tracking shipment data, determining what data can be shared, and determining what data to share, the computing system comprising:
one or more processors; and
a non-transitory computer-readable medium coupled to the one or more processors and the communication unit and storing instructions thereon that, when executed by the one or more processors, cause the computing system to:
receive a request from a user to track a shipment, the shipment having a shipment path specifying a plurality of regions;
retrieve user characteristic data from a user profile associated with the user, the user characteristic data indicating a user location;
retrieve a regional tracking policy for each region of the plurality of regions in the shipment path;
determine, based on the user location, whether the regional tracking policy for each region of the plurality of regions in the shipment path applies to the user; and
responsive to the determining whether the regional tracking policy for each region of the plurality of regions in the shipment path applies to the user:
obfuscate at least part of a set of tracking data of the shipment in accordance with the regional tracking policy when the regional tracking policy applies, including not availing the at least part of the set of tracking data for display in a user interface, and
refrain from obfuscating the set of tracking data when the regional tracking policy does not apply.

12. The computing system of claim 11, wherein the user profile associated with the user is further associated with a set of trusted users and the non-transitory computer-readable medium further stores instructions that, when executed by the one or more processors, cause the computing system to:
responsive to determining that the user profile is associated with the set of trusted users, authenticate the user location.

13. The computing system of claim 11, wherein the user location is a first user location and the non-transitory computer-readable medium further stores instructions that, when executed by the one or more processors, cause the computing system to:
determine, based on shipping data associated with the shipment, a second user location different than the first user location; and
determine whether to use the first user location or the second user location based at least in part on whether the user profile is associated with a set of trusted users.

14. The computing system of claim 11, wherein the user is a first user and the non-transitory computer-readable medium further stores instructions that, when executed by the one or more processors, cause the computing system to:
determine that the first user shares the shipping data with a second user associated with a second user profile;
determine, based on the second user location, whether the regional tracking policy for each region of the plurality of regions in the shipment path applies to the second user;
wherein the obfuscating includes:
obfuscating the at least part of the set of tracking data in accordance with the regional tracking policy for only the first user when the regional tracking policy applies to the first user and does not apply to the second user,
obfuscating the at least part of the set of tracking data in accordance with the regional tracking policy for only the second user when the regional tracking policy applies to the second user and does not apply to the first user, and
obfuscating the at least part of the set of tracking data in accordance with the regional tracking policy for the first user and the second user when the regional tracking policy applies to the first user and the second user; and
wherein the refraining from obfuscating includes:
refraining from obfuscating the set of tracking data when the regional tracking policy does not apply to the first user and the second user.

15. The computing system of claim 14, wherein the first user is a first regional branch of a company located in a first region of the plurality of regions and the second user is a second regional branch of the company located in a second region of the plurality of regions.

16. The computing system of claim 14, wherein the non-transitory computer-readable medium further stores instructions that, when executed by the one or more processors, cause the computing system to:
retrieve a tenant tracking policy for the first user;
determine whether the tenant tracking policy for the first user applies to the second user; and
responsive to the determining whether the tenant tracking policy for the first user applies to the second user:
obfuscate the at least part of the set of tracking data in accordance with the tenant tracking policy when the tenant tracking policy applies, and
refrain from obfuscating the set of tracking data when the tenant tracking policy does not apply.

17. The computing system of claim 14, wherein the non-transitory computer-readable medium further stores instructions that, when executed by the one or more processors, cause the computing system to:
render, using the set of tracking data, shipment information for the first user;
generate, based on the shipment information, a copy of the shipment information for the second user;
wherein obfuscating the at least part of the set of tracking data in accordance with the regional tracking policy for only the second user includes:
applying the obfuscating to the copy of the shipment information for the second user, and
wherein obfuscating the at least part of the set of tracking data in accordance with the regional tracking policy for the first user and the second user includes:
applying the obfuscating to the shipment information and the copy of the shipment information.

18. The computing system of claim 11, wherein the user is a first user of a plurality of users associated with the shipment and the non-transitory computer-readable medium further stores instructions that, when executed by the one or more processors, cause the computing system to:
retrieve a tenant tracking policy for each of the plurality of users;
determine whether the tenant tracking policy for each of the plurality of users applies to the first user; and
responsive to the determining whether the tenant tracking policy for each of the plurality of users applies to the first user:
obfuscate the at least part of the set of tracking data in accordance with the tenant tracking policy when the tenant tracking policy applies, and
refrain from obfuscating the set of tracking data when the tenant tracking policy does not apply.

19. The computing system of claim 11, wherein the non-transitory computer-readable medium further stores instructions that, when executed by the one or more processors, cause the computing system to:
responsive to the retrieving the regional tracking policy for each region of the plurality of regions in the shipment path, assemble the regional tracking policy for each region of the plurality of regions into a shipping tracking policy; and
wherein the determining whether the regional tracking policy for each region of the plurality of regions in the shipment path applies to the user is responsive to the assembling.

20. The computing system of claim 11, wherein:
the obfuscating includes sharing an aggregate of shipping information with the user but not particular position data of the shipment, and
the refraining from obfuscating includes sharing the particular position data of the shipment with the user.
